(19) United States
(12) Patent Application Publication
(10) Pub. No.: US 2012/0181055 A1
(43) Pub. Date: Jul. 19, 2012

(54) High Volume Cover

(75) Inventor: William Harrison Holton, Waxhaw, NC (US)

(73) Assignee: Mr. William Harrison Holton, III, Waxhaw, NC (US)

(21) Appl. No.: 13/006,049

(22) Filed: Jan. 13, 2011

(51) Int. Cl. H02G 3/14

(52) U.S. Cl. 174/66

(57) ABSTRACT

The High Volume Cover is a cover designed to replace the use of flat covers over metal electrical junction boxes and/or metal electrical junction box extensions. The high volume capacity of the cover eliminates the need to stack electrical junction box extensions until the required volume is reached and placing a flat cover over the opening. The increased depth of the High Volume Cover also allows the wires to remain straight instead of coiling the wires and stuffing them into the confined space provided by shallow electrical junction boxes. This will reduce conductor fatigue as the High Volume Cover reduces the need to move the conductors. Insulation nicks will be reduced and heat buildup inside the electrical junction box will be reduced.

### CROSS-REFERENCE TO RELATED APPLICATIONS

| | | |
|---|---|---|
| 2,018,905 | October 1935 | Urbon |
| 2,596,236 | May 1952 | Glosier |
| 4,620,061 | October 1986 | Appelton |
| 7,531,745 | May 2009 | Gretz |

### STATEMENT REGARDING FEDERALLY SPONSORED RESEARCH OR DEVELOPMENT

There is no federally sponsored research or development associated with the invention described wherein.

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates generally to electrical junction box covers and, more particularly, to protectors for electrical wiring inside the outlet boxes

### BACKGROUND OF INVENTION

The High Volume Cover is an electrical component used primarily in, but not limited to, commercial and industrial electrical installations where metal electrical junction boxes are used. A High Volume Cover is used for the purpose of closing a metal electrical junction box, of the type that has perforated knockouts, for the purpose of providing access to conduit and cabling. Once insulated conductors enter the electrical junction with the expressed purpose of making joints between the different conductors the National Electrical Code (2011 NFPA 70 Article 314.16) requires the electrical junction box to be of sufficient size to provide free space for all enclosed conductors. The current solution for providing sufficient space for conductors is to add extension rings in small increments and then install a flat cover over the opening of the last extension. The High Volume Cover eliminates the need to stack one or more extensions. Once all conductors are present in the electrical junction box and joints are made the wires are left extended straight from the opening of the electrical junction box and the High Volume Cover is placed over the extended conductors and secured to the electrical junction box by the same means the extension rings and flat cover are. This is by way of two ANSI 6-32 screws that are provided with the High Volume Cover. The High Volume Cover is placed over the extended conductors is a much faster method of covering the electrical junction box. The National Electrical Code (2011 NFPA 70 Article 300.14) requires these conductors to extend at least three inches outside the opening of the electrical junction box. The six inch depth of the High Volume Cover eliminates the necessity for the conductors to be folded, twisted and/or crammed into the shallower electrical junction box. Therefore the installation time is reduced and safety is increased.

### BRIEF SUMMARY OF THE INVENTION

A high volume cover for electrical junction boxes that can be quickly installed over the wires of said junction box. The wires that extend the proper length from the junction box for which joints are to be made and wire nuts applied to will not need to coiled and stuffed into the junction box. The wires may simply extend straight from the electrical junction box and covered by the High Volume Cover. Making modifications to the contents of the electrical junction box easier due to the fact the wires will have not been coiled. Wire fatigue and compromised insulation is reduced. With the increased volume heat buildup is also reduced.

### BRIEF DESCRIPTION OF THE SEVERAL VIEWS OF THE DRAWING

FIG. 1 is a flat view of the two middle sections and top, detailing the flanges and holes associated with the middle section.

FIG. 2 is a flat view of side A and its flange.

FIG. 3 is a flat view of side B and its flange.

FIG. 4 is the same view as FIG. 1 with the flanges folded up.

FIG. 5 is the same view as FIG. 2 with the flanges of side A folded up.

FIG. 6 is the same view as FIG. 3 with the flanges of side B folded up.

FIG. 7 is a single view of sides A&B from the outside with the flanges folded

FIG. 8 is a bottom view of the middle section with the flanges folded and the side sections A&B attached.

FIG. 9 is the folded view of the middle section.

FIG. 10 is a folded view of the middle section with the mounting screws installed.

FIG. 11 is a view of the top showing the middle section folded and side sections A&B attached. It also shows the holes for the mounting screws.

FIG. 12 is a detail of the mounting screw.

### DETAILED DESCRIPTION OF THE INVENTION

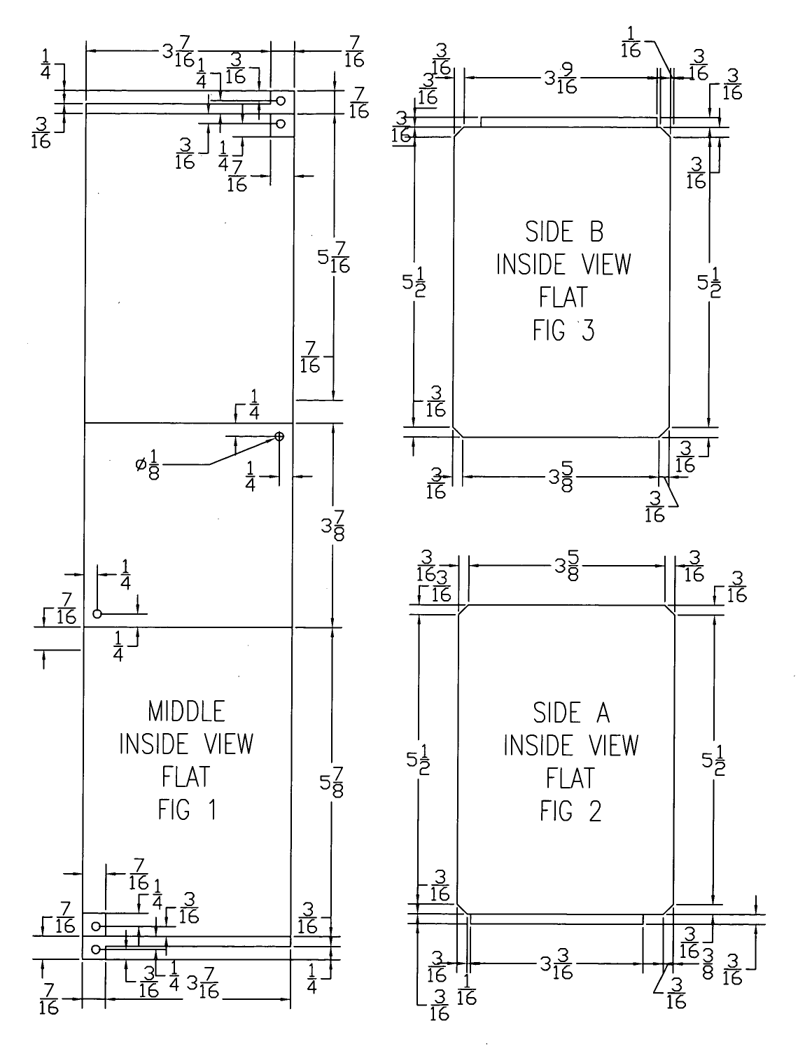

FIG. 1 represents the flat inside view of the entire middle section of the High Volume Cover. The middle section of the High Volume Cover includes two sides the top and two of the four bottom flanges. Two 5/32″ holes are drilled catty-corner to each other. The retaining screw shown in FIG. 12 is held in place by the flanges at the bottom of the two sides. FIG. 10 illustrates the two retaining screws as they are inserted through the two top holes and held in place by the two bottom flanges. At the ends of the two sides is what will become two of the bottom flanges. The narrower portion of the bottom flange is for mating with an electrical junction box and to prevent the wires extending from said box from being pinched when the High Volume Cover is attached. The wider portions of the flanges have 5/32″ holes drilled in them and are designed to secure the end of the retaining screw as shown in FIG. 10. Just above the bottom flange at the end of each side section of the middle section is the captive flange. Once the retaining screw shown in FIG. 12 is passed through the top holes, captive flange and retaining flange a collar will be added to the retaining screw, between the captive flanges and the retaining flanges, to prevent the retaining screw from being completely removed from the completed assembly. The first ⅝″ of the retaining screw shown in FIG. 12 will be tapped with ANSI 6-32 threads. The middle section is stamped from 1/16″ thick galvanized sheet steel.

FIG. 2 represents side A with clipped corners and one of the four bottom flanges. The bottom flanges are for mating with an electrical junction box and to prevent the wires extending from said box from being pinched when the High Volume Cover is attached. The clipped corners will prevent sharp edges from being present when side A is attached to the middle section as shown in FIG. 8 and FIG. 11. Side A will be attached to the middle section by spot welds in six locations, two along each side. Side A is stamped from 1/16″ thick galvanized sheet steel.

FIG. 3 represents side B with clipped corners and one of the four bottom flanges. The bottom flanges are for mating with an electrical junction box and to prevent the wires extending from said box from being pinched when the High Volume Cover is attached. The clipped corners will prevent sharp edges from being present when side B is attached to the middle section as shown in FIG. 8 and FIG. 11. Side B will be attached to the middle section by spot welds in six locations, two along each side. Side B is stamped from 1/16″ thick galvanized sheet steel.

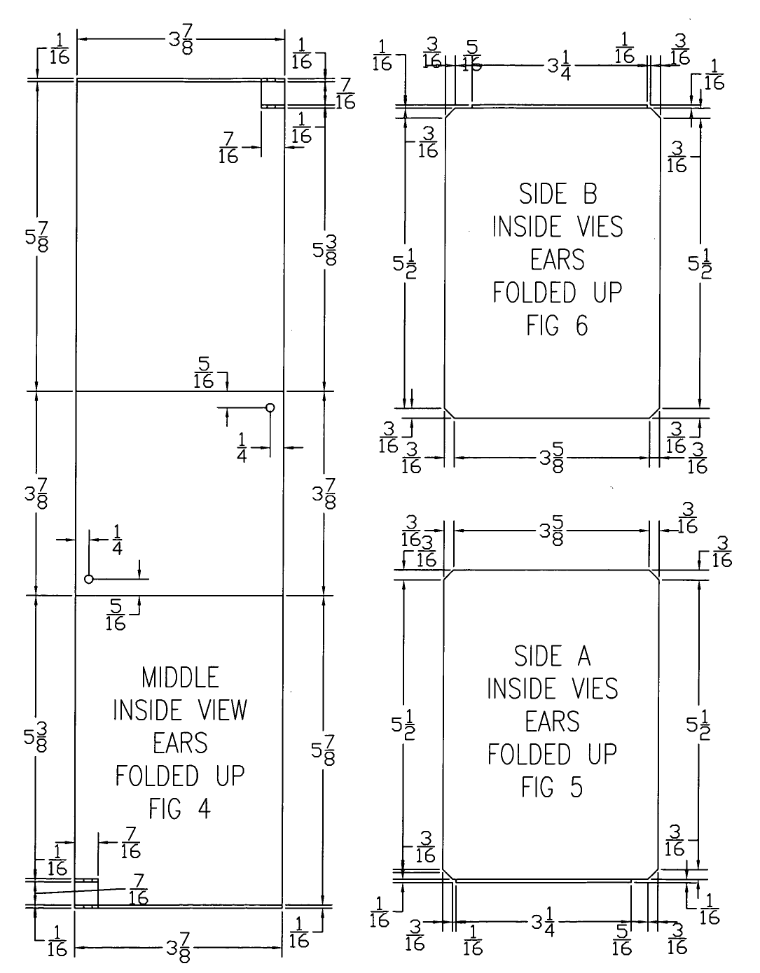

FIG. 4 represents an inside view of the middle section with all the flanges folded up.

FIG. 5 represents side A with the bottom flange turned up.

FIG. 6 represents side B with the bottom flange turned up.

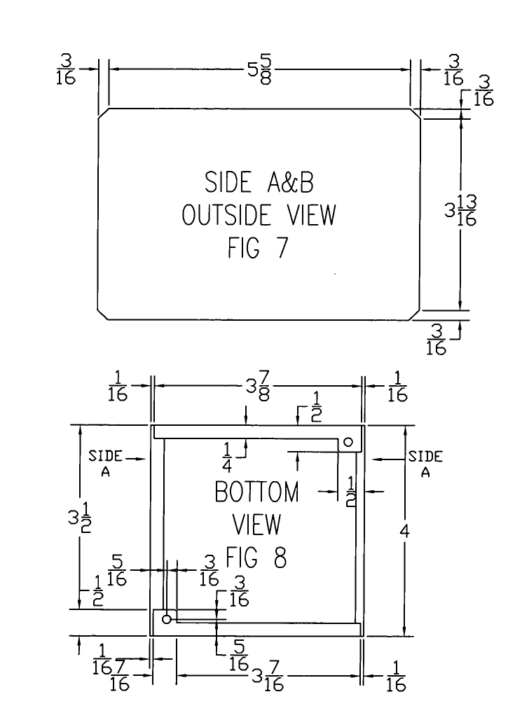

FIG. 7 represents the outside view of sides A&B with the flanges turned away or inside.

FIG. 8 represents the view from the bottom of the High Volume Cover showing the flanges and holes in the retaining portion of the flange.

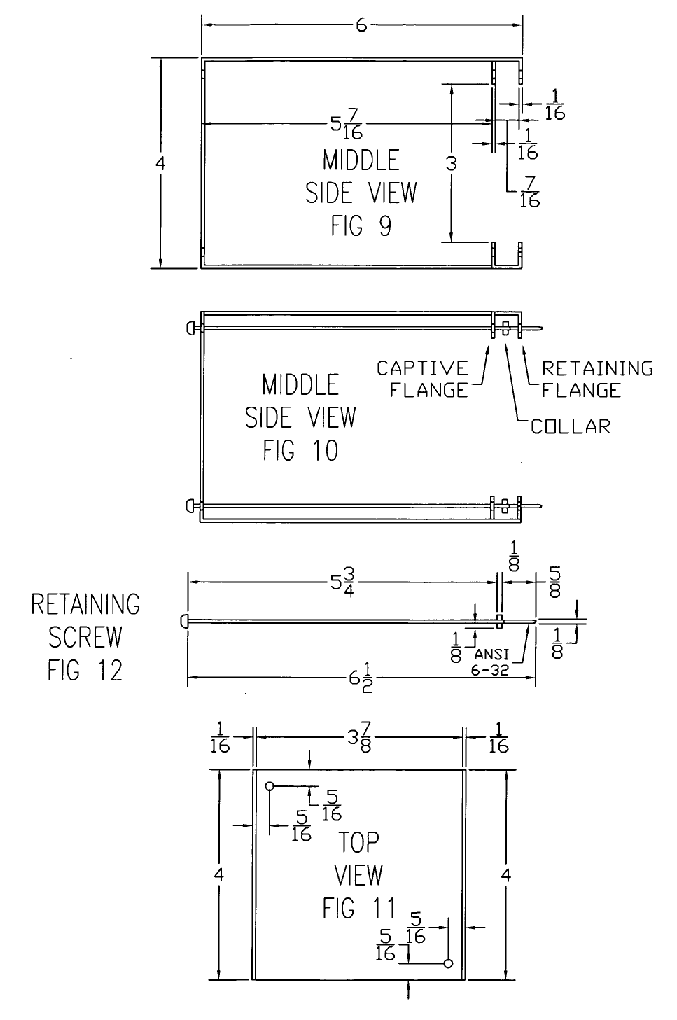

FIG. 9 represents the side view of the middle section of the High Volume Cover. Shown are the two folds made between the top and two sides and the folds made for the bottom, captive and retaining flanges.

FIG. 10 represents the side view of the middle section of the High Volume Cover. Shown is the retaining screws and how they are to be installed in the final assembly.

FIG. 11 represents the top view of the completed assembly. Shown are the two 5/32″ top holes. And sides A&B attached to the middle section.

FIG. 12 represents the detail of the retaining screw. The retaining screw is to be made from Zinc.

Metal electrical junction boxes are primarily used in commercial and industrial application but are not limited to such applications.

Electrical junction boxes are generally used by but not limited to applications where multiple circuits are run to a central location for the utilization equipment being wired, such as lights and receptacles for a particular room in the facility. A circuit usually consists of one hot, one neutral and one ground wire. Because the National Electric Code requires separate neutrals for every circuit; electrical junction boxes are increasingly more crowded with conductors. The High Volume Cover provides multiple advantages for dealing with multiple circuits in one electrical junction box. The High Volume Cover is approximately six inches in depth and will be provided in widths and heights consistent with industry standard electrical junction boxes currently on the market. For example a standard 4×4×1½ inch electrical junction box commonly has a volume of 21 cubic inches. Currently the method for increasing the volume of an electrical junction box is to apply one or more electrical junction box extensions. The High Volume Cover that is designed for a 4×4 electrical junction box would be 4×4×6 and have an approximate volume of 84 cubic inches. Therefore the combined volume of the two boxes together would be 105 cubic inches. This increased volume gives ample space to safely and neatly organize over 20 circuits in one electrical junction box. The increased depth of the High Volume Cover also allows the wires to remain straight instead of coiling the wires and stuffing them into the confined space provided by shallow electrical junction boxes. The ability to leave the wires straight reduces installation time, reduces heat buildup and decreases the risk of wire fatigue by coiling and uncoiling the conductors. Therefor safety is increased. The method of increasing electrical junction box volume becomes a problem particularly during changes to new installations or retrofit applications where additional circuits are added. When additional circuits are added the volume of the existing electrical junction may not be sufficient. By adding additional volume to the existing electrical junction box by stacking additional electrical junction box extensions the existing conductors may not extend the required 3″ from the opening. Although the additional electrical junction box extensions can be removed to reveal the required 3″ of conductors extending from the opening of the original or primary box, the time required to do so is greatly increased. When electrical junction box extensions are added and removed and the conductors in those boxes are coiled and uncoiled multiple times the integrity of the conductors and the insulation on those conductors is compromised. Therefor safety is increased.

What is claimed is:

1: A High Volume Cover for the purpose of sealing a metal electrical junction box, of the type that has perforated knockouts, for the purpose of providing access to conduit and cabling. The High Volume Cover has a 6″ depth allowing the cover to be placed over conductors extending straight from the opening of an electrical junction box without the need to coil the wires and stuff them into said box.

2: The High Volume Cover of claim 1 wherein has four 6″ solid sides and a solid top of varying sizes to fit industry standard size electrical junction boxes. The bottom is open.

3: The High Volume Cover of claim 2 wherein is supplied with two 6½″ retaining screws for the purpose of securing the cover to industry standard electrical junction boxes. Said screws pass through two holes caddy-corner from each other in the top and extend through two like holes in a flange on the open bottom.

4: The High Volume Cover of claim 3 wherein is designed to reduce installation time, reduce conductor fatigue, reduce nicks in conductor insulation and reduce heat buildup between conductors in the covered electrical junction box.
